(19) United States
(12) Patent Application Publication
(10) Pub. No.: US 2017/0255940 A1
(43) Pub. Date: Sep. 7, 2017

(54) SYSTEMS, METHODS, APPARATUS, AND COMPUTER-READABLE MEDIA FOR AGE VERIFICATION

(71) Applicant: MASTERCARD INTERNATIONAL INCORPORATED, Purchase, NY (US)

(72) Inventor: Manoneet KOHLI, O Fallon, MO (US)

(21) Appl. No.: 15/058,003

(22) Filed: Mar. 1, 2016

(51) Int. Cl. G06Q 20/40; G06Q 20/34

(52) U.S. Cl. CPC G06Q 20/40145; G06Q 20/346

(57) ABSTRACT

Systems, methods, apparatus, and computer-readable storage media are described which respond to a request to verify the age of a cardholder, wherein said response is based on biometric information of the cardholder.

### BACKGROUND

Field of the Disclosure

Aspects of the disclosure relate in general to automatic age verification based on biometric information.

Description of the Related Art

A payment card is a card that can be used by a cardholder and accepted by a merchant to make a payment for a purchase or in payment of some other obligation. Payment cards include credit cards, debit cards, charge cards, and Automated Teller Machine (ATM) cards. Payment cards provide the clients of a financial institution (“cardholders”) with the ability to pay for goods and services without the inconvenience of using cash.

In a different field, society restricts the purchase or use of certain goods or services from minors. For example, in most states in the United States, alcohol is prohibited from sale to individuals less than twenty-one years of age, while tobacco products cannot be sold to individuals less than eighteen years old.

As a result of these restrictions, some under-age minors attempt to make purchases using fraudulent (“fake”) identification. These “fake IDs” include counterfeit drivers licenses and other forged identification. The purchase of fake identification fuels criminal enterprise and other unsavory activities.

In some jurisdictions, strict penalties are incurred to merchants when violations occur. These penalties include monetary penalties or potential loss of business licenses.

In another context, a merchant may impose an age restriction in order to offer a discount or other incentive to purchasers having at least a minimum age (e.g., senior citizens).

### SUMMARY

Embodiments include systems, methods, apparatus, and computer-readable media for verification of an age of a cardholder, which may be used to comply with age restrictions on purchases.

A method for age verification according to a general configuration is described. The method includes receiving, by a processor, a request by a merchant device to authenticate a cardholder and a request by the merchant device to verify an age of the cardholder. The method also includes sending, by the processor and via a network interface and in response to at least one among said requests, a challenge to a device of the cardholder. The method also includes receiving, by the processor and via the network interface, an answer by the device of the cardholder to the challenge. The method also includes sending, by the processor, a response to said request to verify the age of the cardholder, wherein said response is based on the answer to the challenge. In this method, the answer to the challenge is based on biometric information of the cardholder. Computer-readable storage media (e.g., non-transitory media) having instructions that cause one or more processors executing the instructions to perform such a method are also disclosed.

An apparatus for age verification according to a general configuration is described. The apparatus includes a network interface and a server. The server is configured to receive a request by a merchant device to authenticate a cardholder and a request by the merchant device to verify an age of the cardholder. The server is also configured to send, via the network interface and in response to at least one among said requests, a challenge to a device of the cardholder. The server is also configured to receive, via the network interface, an answer by the device of the cardholder to the challenge. The server is also configured to send a response to said request to verify the age of the cardholder, wherein said response is based on the answer to the challenge. In this apparatus, the answer to the challenge is based on biometric information of the cardholder.

### BRIEF DESCRIPTION OF THE DRAWINGS

FIG. 1 shows a flowchart for a method M100 for age verification that includes tasks T100, T200, T300, and T400.

FIG. 2 shows a flowchart for an implementation M200 of method M100.

FIG. 3 shows a flowchart for an implementation M210 of method M200.

FIG. 4A shows a flowchart for an implementation M220 of method M200.

FIG. 4B shows a flowchart of one example of an enrollment process.

FIG. 4C is a flowchart showing an example of a process context within which method M100 may be performed.

FIG. 5A shows a block diagram of an apparatus A100 for age verification that includes a network interface NI10 and a server SV10.

FIG. 5B shows a block diagram of an implementation A110 of apparatus A100.

FIG. 6 depicts communications links within a system that includes an instance ACS10 of an implementation of apparatus A100.

FIGS. 7A-7F show examples of indexed sets of age groups.

FIG. 8A shows a block diagram of an implementation SV20 of server SV10.

FIG. 8B shows a block diagram of an implementation SV30 of server SV10.

FIG. 9A shows a block diagram of an implementation CD20 of a cardholder device CD10.

FIG. 9B shows a block diagram of an implementation CD30 of the cardholder device CD10.

FIG. 10A shows a block diagram of an implementation SV50 of server SV10.

FIG. 10B shows a block diagram of an implementation CD50 of cardholder device CD10.

FIG. 11A shows a block diagram of a POS system including an implementation A200 of apparatus A100.

FIG. 11B shows a block diagram of an implementation CD100 of cardholder device CD10.

### DETAILED DESCRIPTION

For a point-of-sale purchase in which a cardholder is attempting to purchase an age-restricted product, the merchant may initiate an age verification operation that includes verifying the date of birth on a document presented by the cardholder (e.g., a driver's license). As noted above, however, the document presented by the cardholder may be fraudulent.

For an electronic commerce transaction (e.g., an online purchase) in which a cardholder is attempting to purchase an age-restricted product, the merchant may initiate an age verification operation that is based on the registered date of birth of the cardholder. Such a validation procedure is not foolproof, however, and can be broken.

Aspects include payment network embodiments that verify the age of a cardholder as part of a payment authorization process. Further aspects include embodiments that verify the age of a cardholder as part of a payment authorization process when payment is made at the point of sale via a mobile payment device. Further aspects include embodiments that verify the age of a cardholder as part of a payment authorization process when payment is made online via a mobile payment device.

The systems and processes are not limited to the specific embodiments described herein. In addition, components of each system and each process can be practiced independently and separately from other components and processes described herein. Each component and process also can be used in combination with other assembly packages and processes.

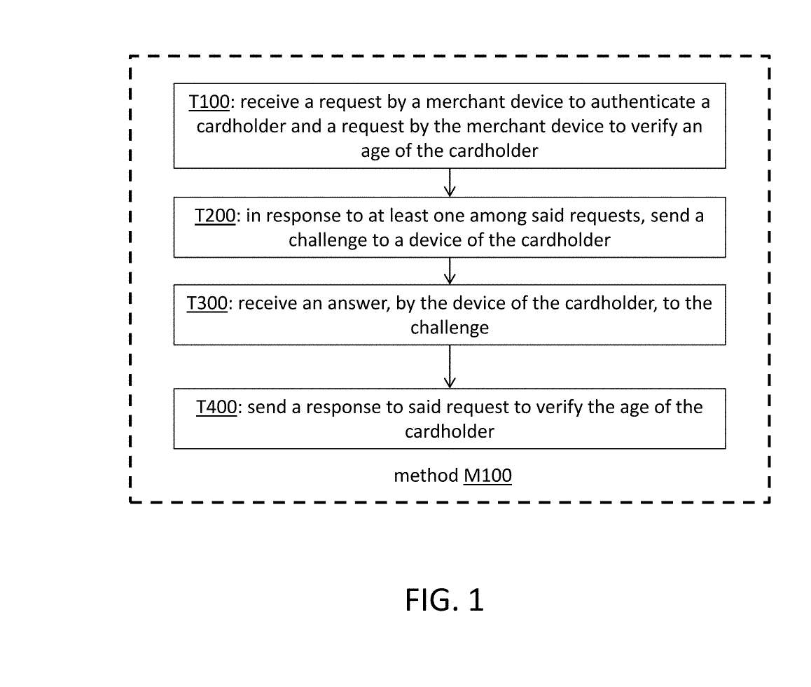

FIG. 1 shows a flowchart of a method for age verification according to a general configuration that includes tasks T100, T200, T300, and T400. Task T100 receives a request by a merchant device to authenticate a cardholder and a request by the merchant device to verify an age of the cardholder (e.g., requests RQ10 and RQ20, respectively, as described herein). In one example, the merchant device is a point-of-sale (POS) device (e.g., a register, a self-checkout terminal, etc.). In another example, the merchant device is a server configured to process online transactions.

In response to at least one of these requests, task T200 sends a challenge to a device of the cardholder (e.g., challenge CH10 as described herein). For a point-of-sale transaction, the device of the cardholder may be a mobile payment device (e.g., a smartphone). For an online transaction, the device of the cardholder may be a smartphone or other portable computing device (e.g., laptop or tablet) running a web browser (e.g., Microsoft Edge, Microsoft Internet Explorer, Mozilla Firefox, Google Chrome).

Task T300 receives an answer, by the device of the cardholder, to the challenge (e.g., answer AN10 as described herein). This answer is based on biometric information of the cardholder. For example, the answer may indicate the result of an operation that uses biometric information of the cardholder. Task T400 sends a response to the request to verify the age of the cardholder (e.g., response RS20 as described herein), in which this response is based on the answer to the challenge.

The biometric information of the cardholder may include information from a fingerprint of the cardholder. For example, the biometric information may include one or more feature vectors obtained from an image of a fingerprint of the cardholder by one or more analysis operations, such as discrete wavelet transform (DWT), direct cosine transform (DCT), principal component analysis (PCA), singular value decomposition (SVD), etc. The biometric information of the cardholder may include information obtained from a facial image of the cardholder by one or more operations, such as wrinkle analysis, calculation of one or more facial feature ratios, etc. In a further example, the biometric information of the cardholder includes information from a voice of the cardholder, such as voice modulation, Gaussian mixture model (GMM) mean supervectors, etc.

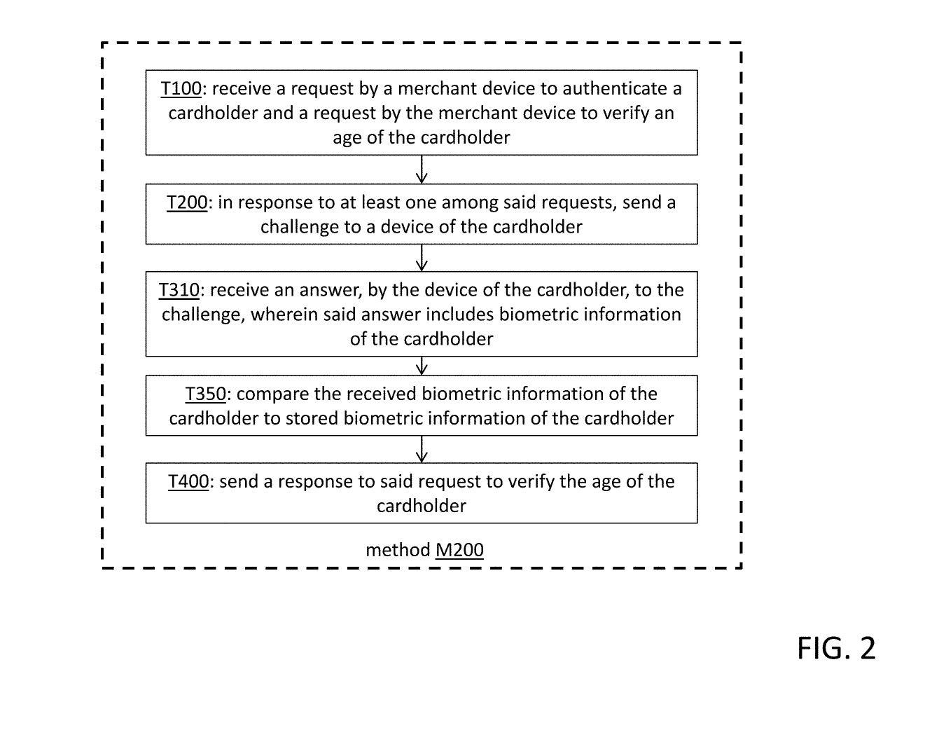

Method M100 may be implemented in different ways. For example, FIG. 2 shows a flowchart of an implementation M200 of method M100. Method M200 includes an implementation T310 of task T300 in which the received answer includes biometric information of the cardholder (e.g., a feature vector derived from a scan of a fingerprint of the cardholder using DWT and PCA). Method M200 also includes a task T350 that compares the received biometric information of the cardholder to stored biometric information of the cardholder. For example, task T350 may calculate a distance between a received feature vector and a stored feature vector that is associated with the cardholder's account number (e.g., by computing a distance between the vectors or other similarity measure, and comparing the result to a threshold value).

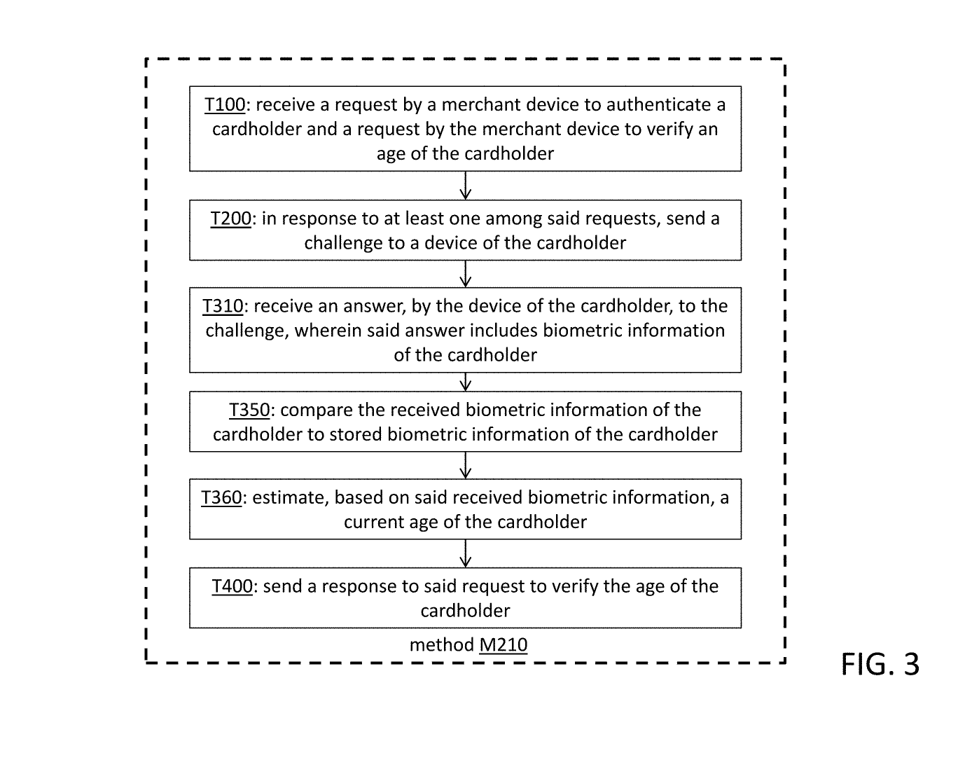

FIG. 3 shows a flowchart of an implementation M210 of method M200. Method M210 includes a task T360 that estimates a current age of the cardholder, based on the received biometric information. Task T360 may estimate the current age by using the received biometric information to select one among a set of age groups. For example, task T360 may classify a received biometric feature vector with reference to a database of classified feature vectors by using a classifier, such as a K-nearest-neighbor (KNN) classifier, a support vector machine (SVM) classifier, or a minimum distance classifier.

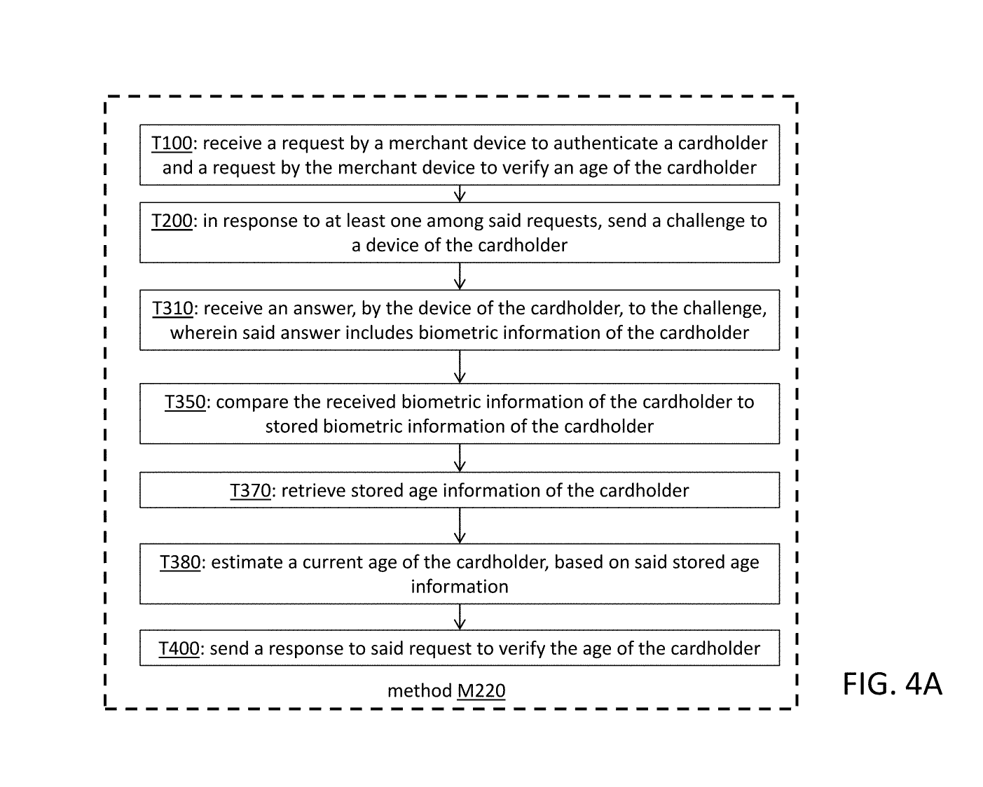

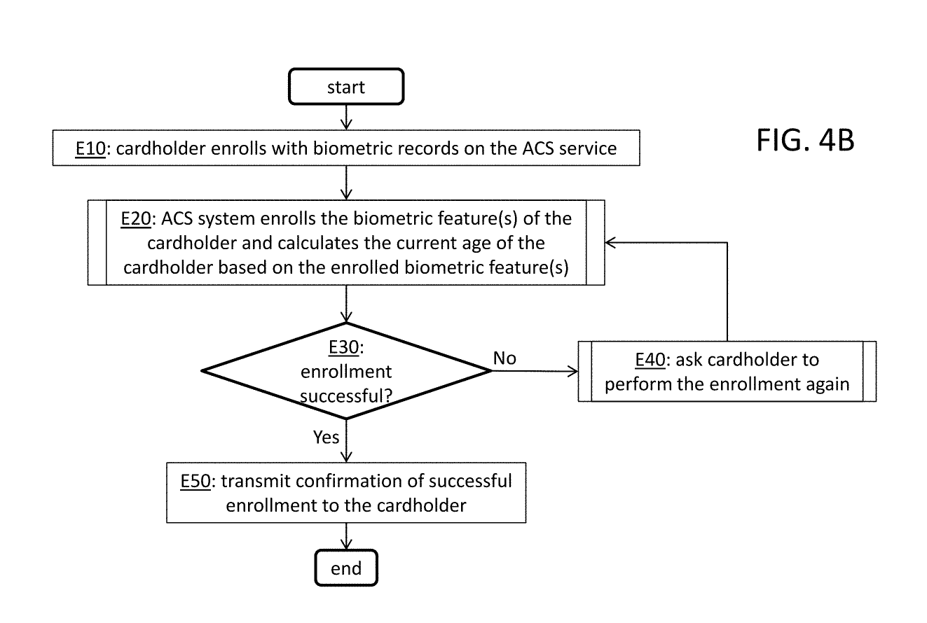

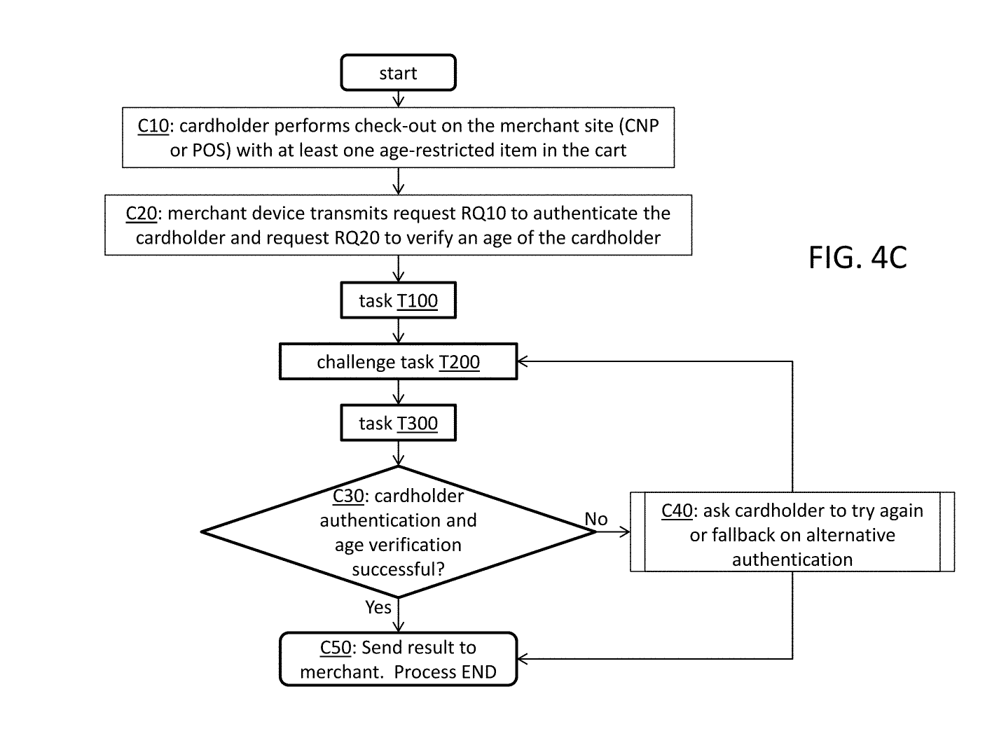

FIG. 4A shows a flowchart of an alternate implementation M220 of method M200. Method M220 includes a task T370 that retrieves stored age information of the cardholder. The stored age information may be calculated from biometric information of the cardholder at a time of the cardholder's enrollment in a biometric authentication program. In one such example, the stored age information includes the date of enrollment and an estimated age of the cardholder as calculated from biometric information of the cardholder as presented on that date. In another such example, the stored age information includes an estimated birth date of the cardholder, as calculated from the date of enrollment and biometric information of the cardholder as presented on that date. The estimated birth date may be calculated, for example, by estimating the current age of the cardholder from the biometric information presented at enrollment and subtracting it from the date of enrollment.

Method M220 also includes a task T380 that estimates a current age of the cardholder, based on the stored age information. For example, task T380 may estimate the current age by adding an offset to the estimated age of the cardholder at the time of enrollment, where the offset is calculated as the difference between the date of enrollment and the current date. Alternatively, task T380 may estimate the current age as a difference between the estimated birth date of the cardholder and the current date. In a further alternative, task T380 may be replaced by a task T390 that calculates a required birth date (e.g., by subtracting an age indicated in the request from the current date). In this case, compliance may be determined by comparing the estimated birth date of the cardholder to the required birth date.

FIG. 4B shows a flowchart of one example of an enrollment process that includes steps E10, E20, E30, E40, and E50. In step E10, the cardholder enrolls with biometric records (e.g., a fingerprint scan, a voice recording, and/or a facial image) on an ACS (Access Control Server) service. In step E20, the ACS system enrolls the biometric feature(s) of the cardholder. Step E20 also calculates the current age of the cardholder based on the enrolled biometric feature(s) as discussed above. Step E30 determines whether the enrollment was successful. If not, step E40 asks the cardholder to perform the enrollment again, and the process returns to step E20 (or to step E10). If yes, step E50 transmits confirmation of successful enrollment to the cardholder.

It may be desired to implement task T200 to cause presentation at cardholder device CD10 of a request for the cardholder's consent to share age verification information with the merchant. For example, task T200 may be implemented to cause a message such as the following to appear on a display of device CD10: “Your purchase includes an age-restricted item. By proceeding with this purchase, you are consenting to have [Issuer] verify to the merchant that your age is not less than the minimum age required for this purchase.” Alternatively or additionally, it may be desired to obtain the cardholder's consent to sharing age-verification information during the initial enrollment of the cardholder.

FIG. 4C is a flowchart showing an example of a process context within which method M100 may be performed. In step C10, a cardholder performs check-out on the merchant site (whether in the card-not-present (CNP) domain or in the point-of-sale/service (POS) domain) with at least one age-restricted item in the cart. In step C20, the merchant device transmits request RQ10 to authenticate the cardholder and request RQ20 to verify an age of the cardholder. Tasks T100, T200, and T300 as described herein are then performed. If cardholder authentication and/or age verification is not successful (step C30), step C40 asks the cardholder to try again or falls back on alternative authentication (e.g., entering a password or a personal identification number (PIN), presenting documentation such as a driver's license, etc.). Otherwise, step C50 (e.g., including task T400) sends the result to the merchant.

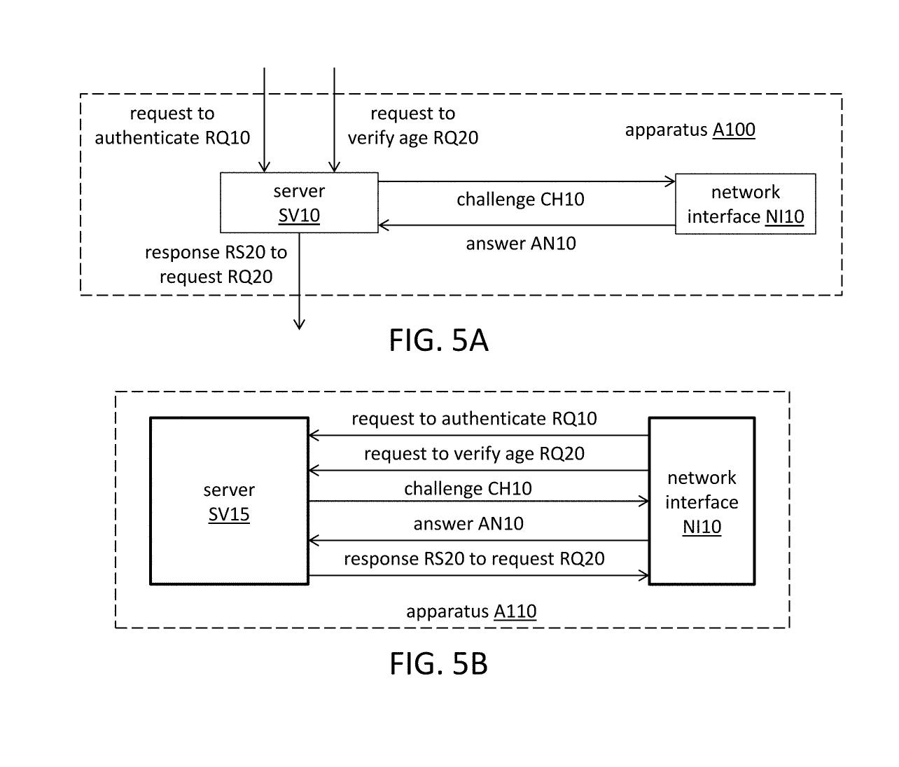

FIG. 5A shows a block diagram for an apparatus A100 for age verification according to a general configuration. Apparatus A100 includes a network interface NI10 and a server SV10. Network interface NI10 may be any data port as is known in the art for interfacing, communicating or transferring data across a computer network; examples of such networks include Transmission Control Protocol/Internet Protocol (TCP/IP), Ethernet, Fiber Distributed Data Interface (FDDI), token bus, and token ring networks. Server SV10 is a machine (including one or more instances of any central processing unit, microprocessor, micro-controller, or other computational device known in the art), or a computer program executing on such a machine, that waits for and responds to requests RQ10 and RQ20. It is understood that the at least one computational device may temporarily store data and instructions in a Random Access Memory (RAM) (not shown), as is known in the art.

Server SV10 is configured to receive a request RQ10 to authenticate a cardholder and a request RQ20 to verify an age of the cardholder (e.g., as described above with reference to task T100).

Server SV10 is also configured to send, via network interface NI10 and in response to at least one among said requests, a challenge CH10 to a device of the cardholder (e.g., as described above with reference to task T200). Server SV10 is also configured to receive, via network interface NI10, an answer AN10 to the challenge by the device of the cardholder (e.g., as described above with reference to task T300). Server SV10 is also configured to send a response RS20 to said request RQ20 to verify the age of the cardholder (e.g., as described above with reference to task T400), wherein the response is based on the answer to the challenge. In this apparatus, the answer to the challenge is based on biometric information of the cardholder.

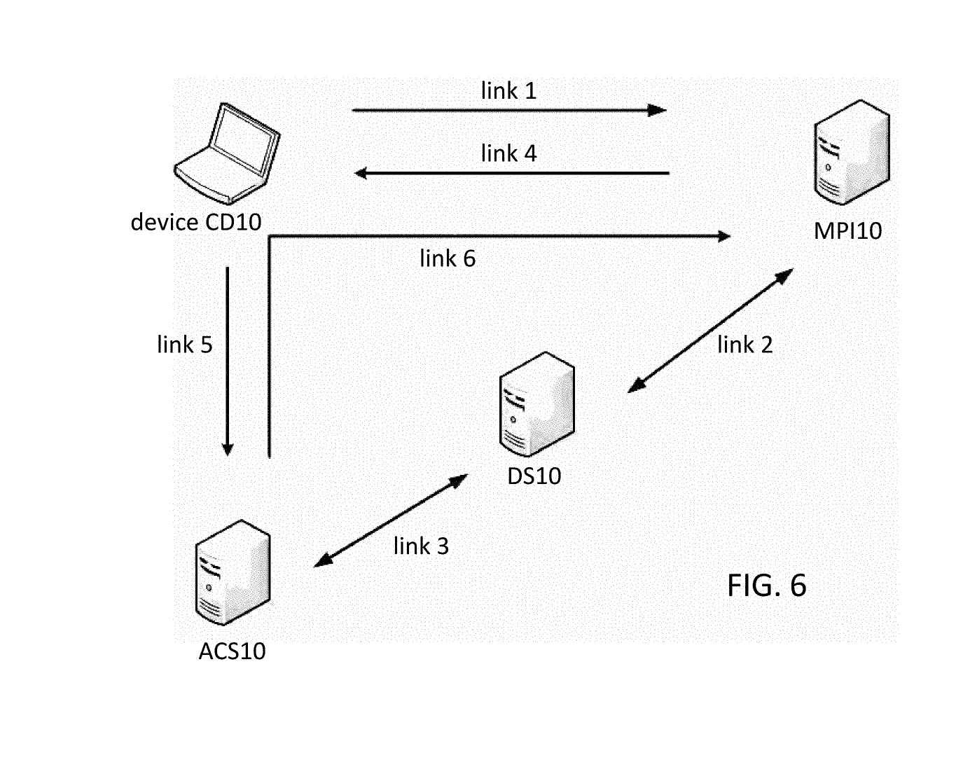

FIG. 5B shows a block diagram of an implementation A110 of apparatus A100 in which an implementation SV15 of server SV10 is arranged to receive requests RQ10 and RQ20 via network interface NI10 and to send response RS20 via network interface NI10. Server SV15 may be arranged, for example, to receive requests RQ10 and RQ20 from a merchant device and to send response RS20 to the merchant device. FIG. 6 shows a flow of data transmissions among devices in a network that includes a device CD10 of the cardholder, a merchant plug-in MPI10 executing on a merchant device, an access control server ACS10 that includes an implementation of apparatus A100, and a directory server DS10. Plug-in MPI10 may be implemented as one or more software modules integrated into the merchant's website that provide an interface between apparatus A100 and the merchant's payment processing software. The MPI may include, for example, a software development kit (SDK) and/or library files or functions.

FIG. 6 depicts a scenario in which the cardholder shops at the merchant (whether at the point-of-sale, or online via device CD10) and, when ready to checkout, enters the appropriate payment information via device CD10, including the account number of the payment card to be used for the purchase. This payment information is sent to merchant plug-in MPI10 over link 1. (It may be desired or required to implement each of links 1-6 as shown in FIG. 6 as a secure link, e.g., using a version of the Secure Socket Layer (SSL) protocol or a version of the Transport Layer Security (TLS) protocol.)

In this case, the item or items to be purchased (e.g., in the cardholder's cart) includes an item that is tagged by the merchant as age restricted. An age-restricted item may be an item whose sale is restricted by law to persons having at least a minimum age (e.g., tobacco, alcoholic beverages, certain medications, firearms ammunition). Alternatively or additionally, an age-restricted item may be an item classified as having a high potential for abuse (e.g., aerosol spray paint, flammable liquids). As part of an existing program to ensure compliance with local regulation and/or merchant policy, the merchant's system may be configured to identify such items by, for example, Universal Product Code (UPC), stockkeeping unit (SKU), and/or other indicator that identifies the particular stock item in the merchant's inventory.

Other examples of an age-restricted item include an alternate price for an item, which price is available only to a purchaser having a minimum age (for example, 50, 55, 60, 62, or 65 years), and a coupon or other offer that is redeemable only by such a purchaser. Such a coupon or other offer may cause a reduction in the price charged for one or more items in the cart (e.g., as an amount to be subtracted from the original price or as a percentage to be subtracted from the original price) or a reduction in the price charged for the entire order (e.g., as an amount or percentage to be subtracted).

Over link 2, merchant plug-in MPI10 queries directory server DS10 to verify the enrollment status of the issuer of the payment card being presented by the cardholder. In one example, this query is a message that is compliant with a version of the 3-D Secure Protocol and which includes the account number of the cardholder and a Verify Enrollment Request (VEReq) field.

If directory server DS10 indicates that the issuer is participating, then it forwards a request over link 3 to the access control server ACS10 (e.g., operated by the issuer of the payment card of the cardholder) to check the enrollment status of the cardholder. The network may include many instances of access control server ACS10, and the configuration information in the directory within server DS10 indicates which access control server will perform the check. The resulting enrollment verification response will flow over link 3 and link 2 back to merchant plug-in MPI10 (e.g., as a message that includes a Verify Enrollment Response (VERes) field).

If server ACS10 indicates that the cardholder is enrolled, merchant plug-in MPI10 sends request to authenticate RQ10 and request to verify age RQ20 to cardholder device CD10 (e.g., to the cardholder's browser) over link 4. For example, plug-in MPI10 may create and send a message that includes request RQ10 as a Payer Authentication Request (PAReq) field. In such case, plug-in MPI10 may send request to verify age RQ20 as another field of the same message. In one such example, the field specifies a minimum age (e.g., as a value of a field, or as an index into a list of age groups as described herein). In another such example, request RQ20 specifies a minimum age and a maximum age (e.g., as two values of a field, as two different fields, or as two indices into a list of age groups).

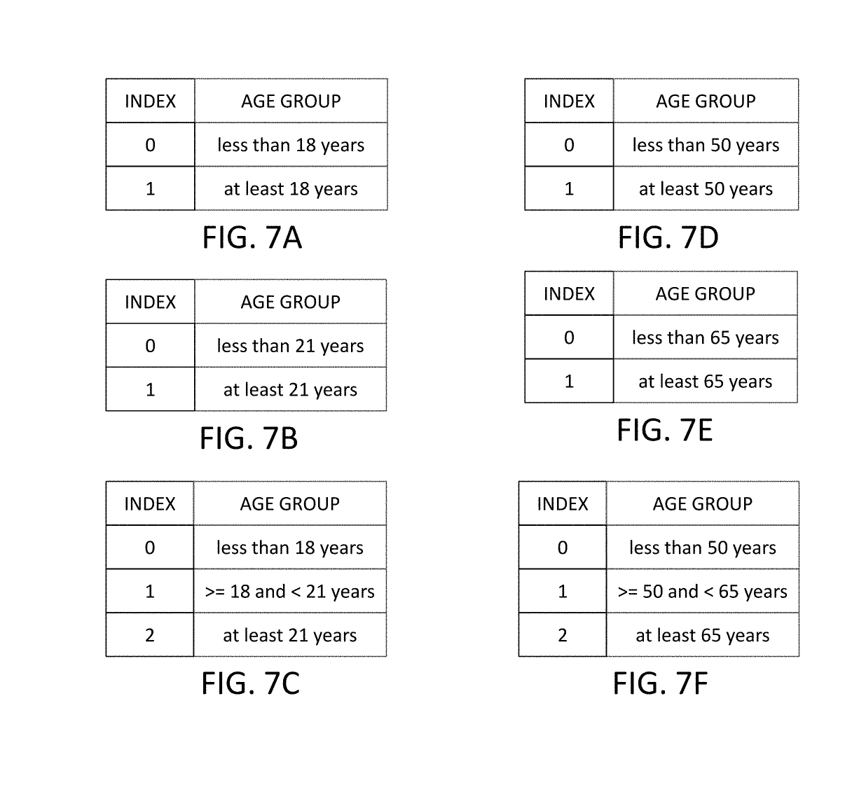

FIGS. 7A-7F show six different examples of indexed lists of age groups. In the example of FIG. 7A, index 0 indicates an age of less than 18 years, and index 1 indicates an age of at least 18 years. In the example of FIG. 7B, index 0 indicates an age of less than 21 years, and index 1 indicates an age of at least 21 years. In the example of FIG. 7C, index 0 indicates an age of less than 18 years, index 1 indicates an age of at least 18 years and less than 21 years, and index 2 indicates an age of at least 21 years. In the example of FIG. 7D, index 0 indicates an age of less than 50 years, and index 1 indicates an age of at least 50 years. In the example of FIG. 7E, index 0 indicates an age of less than 65 years, and index 1 indicates an age of at least 65 years. In the example of FIG. 7F, index 0 indicates an age of less than 50 years, index 1 indicates an age of at least 50 years and less than 65 years, and index 2 indicates an age of at least 65 years.

Cardholder device CD10 redirects the message to server ACS10 over link 5 to perform cardholder authentication. When server ACS10 receives request RQ10, it causes the user authentication dialog to begin by sending challenge CH10 to cardholder device CD10 (e.g., over a secure link). This in turn may cause a separate authentication window to appear on device CD10 that will facilitate the cardholder authentication process. In this process, device CD10 prompts the cardholder to enter biometric information (e.g., to capture a fingerprint scan, a facial image, and/or a voice recording) and sends answer AN10 to server ACS10 (e.g., over a secure link) in a form determined by the particular implementation of apparatus A100 as described herein.

If server ACS10 successfully authenticates the cardholder, then it calculates an age verification result VR10 (e.g., as described herein with reference to task T360 or task T380). Alternatively, server ACS10 obtains the age verification result VR10 from device CD10. In either case, server ACS10 sends response RS20, based on age verification result VR10, to plug-in MPI10 over link 6. In one example, server ACS10 sends response RS20 as a field within a Payer Authentication Response (PARes) message that also includes a response RS10 to request to authenticate RQ10, such as a Universal Cardholder Authentication field (UCAF) having an authentication value responsive to the request (e.g., an Accountholder Authentication Value (AAV) or Cardholder Authentication Verification Value (CAVV)).

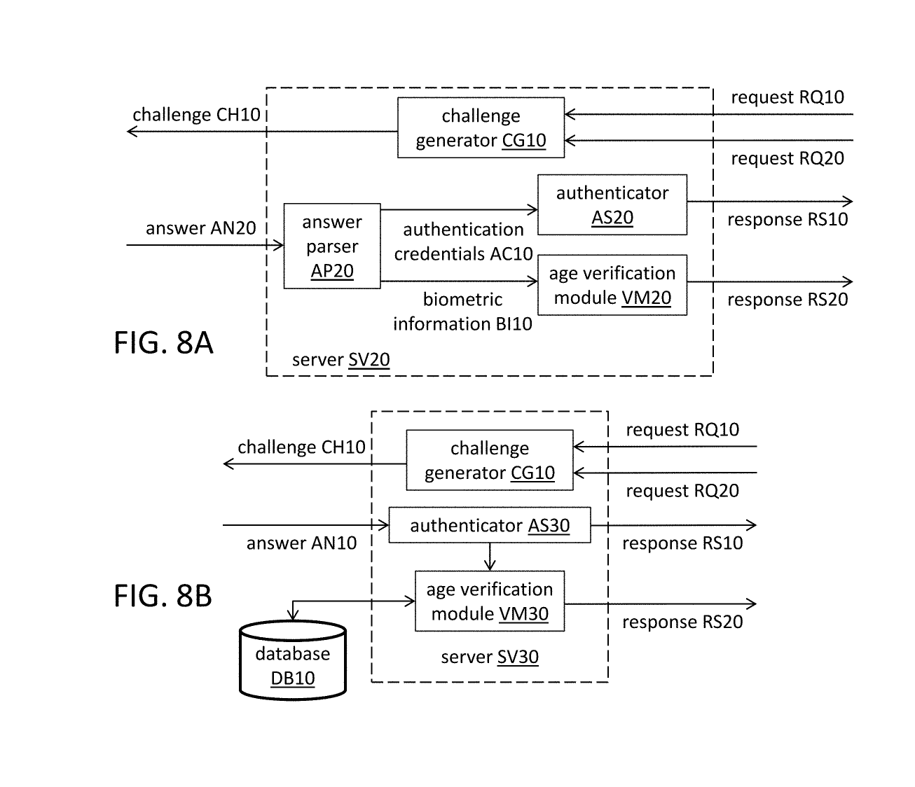

Apparatus A100 may be implemented to perform the authentication and age verification operations. FIG. 8A shows a block diagram of an implementation SV20 of server SV10 that includes a challenge generator CG10, an authenticator AS20, and an age verification module VM20. Challenge generator CG10 generates challenge CH10 in response to at least one among requests RQ10 and RQ20 (e.g., as described herein with reference to task T200). Challenge CH10 may include a command to initiate an authentication operation (e.g., to call an authentication function and/or to open an authentication window) or a command to return an authentication value. Authenticator AS20 receives authentication credentials AC10 (e.g., biometric information, a password, etc.) and produces a corresponding authentication result as response RS10. Module VM20 receives the biometric information BI10 and produces a corresponding age verification result (e.g., as described herein with reference to task T360) as response RS20. As shown in FIG. 8A, server SV20 may also include an answer parser AP20 configured to obtain authentication credentials AC10 and biometric information BI10 from an implementation AN20 of answer AN10 (e.g., by parsing a message form of answer AN20 into its component fields).

FIG. 8B shows a block diagram of another implementation SV30 of server SV10 that includes challenge generator CG10, an authenticator AS30, and an age verification module VM30. Authenticator AS30 receives answer AN10 as biometric information and produces a corresponding authentication result as response RS10. In response to an indication by authenticator AS30 of a successful authentication result, module VM30 retrieves stored age information for the cardholder from a database DB10 and produces a corresponding age verification result based on this stored age information (e.g., as described herein with reference to tasks T370 and T380) as response RS20. Database DB10 may be implemented within apparatus A100 or, alternatively, the corresponding server (e.g., SV30) may be implemented to retrieve the stored age information from database DB10 via network interface NI10 or via another network interface. Challenge generator CG10, parser AP10, authenticator AS20 or AS30, and age verification module VM20 or VM30 may be implemented, for example, as software components of server SV10 or as software modules executing on one or more devices of server SV10.

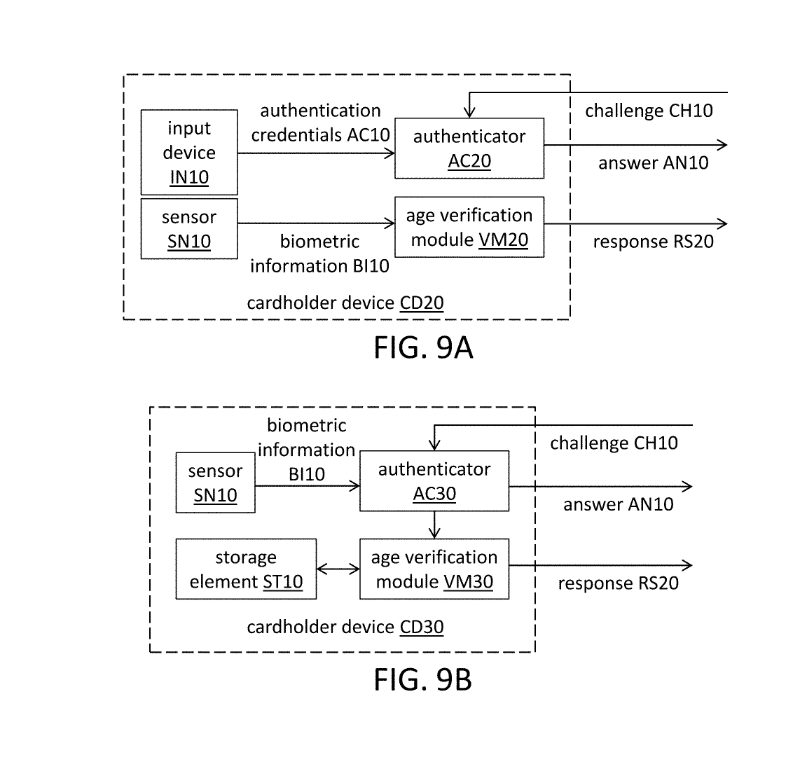

Alternatively, cardholder device CD10 may be implemented to perform the authentication and age verification operations. FIG. 9A shows a block diagram of an implementation CD20 of device CD10 that includes an authenticator AC20 and age verification module VM20 as described above. In response to challenge CH10, authenticator AC20 produces an authentication result, based on authentication credentials AC10 from an input device IN10 (e.g., one or more among a camera, a microphone, a fingerprint sensor, a keypad, and a touchscreen), as answer AN10. In this example, age verification module VM20 is arranged to receive biometric information BI10 from a sensor SN10 (e.g., one or more among a camera, a microphone, and a fingerprint sensor). FIG. 9B shows a block diagram of an implementation CD30 of device CD10 that includes an authenticator AC30 and age verification module VM30 as described above. In response to challenge CH10, authenticator AC30 produces an authentication result, based on biometric information BI10 from sensor SN10, as answer AN10. In this case, and in response to an indication by authenticator AC30 of a successful authentication result, module VM30 is arranged to retrieve the stored age information for the cardholder from a storage element ST10, which may be implemented as a conventional read/write memory such as a flash memory, memory stick, transistor-based memory, or other computer-readable memory device as is known in the art for storing and retrieving data. It may be desired to implement storage element ST10 as secure storage that is not otherwise accessible to other applications that may be executing on cardholder device CD30.

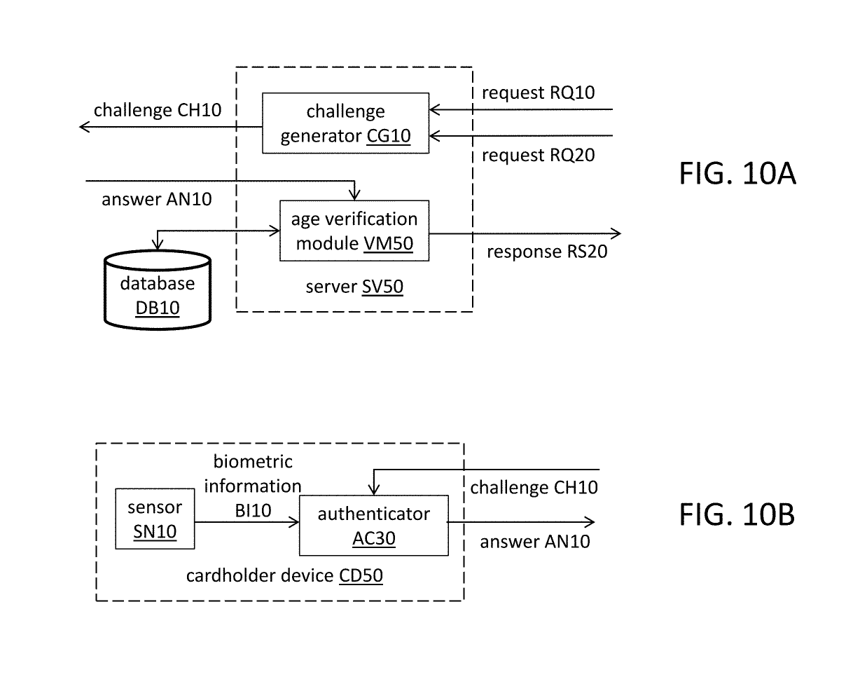

In a further alternative, apparatus A100 may be implemented to perform the age verification operation, and cardholder device CD10 may be implemented to perform the authentication operation. FIGS. 10A and 10B show an implementation SV50 of server SV10 and an implementation CD50 of device CD10, respectively, within such a system. In response to receipt of an answer AN10 that indicates a successful authentication result, module VM50 retrieves stored age information for the cardholder from a database DB10 and produces a corresponding age verification result based on this stored age information (e.g., as described herein with reference to tasks T370 and T380) as response RS20. Any of servers SV20, SV30, and SV50 may also be realized as implementations of server SV15 as described above.

In another example, server SV10 includes a FIDO server (e.g., as specified in the FIDO Alliance Universal Authentication Framework (UAF) Specification (FIDO Alliance, Inc., Wakefield, Mass., fidoalliance.org)) that is arranged to receive requests RQ10 and RQ20 from a relying party web server app. For example, request RQ10 may be a request to initiate authentication, and request RQ20 may be delivered in the same message or document. In response to request RQ10, the FIDO server may generate a UAF authentication request that includes challenge CH10. Authenticator AC20 or AC30 may be implemented as a FIDO authenticator (e.g., as specified in the FIDO Alliance UAF Specification) that verifies the user and returns a signed UAF authentication response as answer AN10. Upon validating the UAF authentication response, server SV10 sends a verification result as response RS10, and response RS20 may be delivered in the same message or document.

Request RQ20 may be implemented to specify a minimum age (e.g., 18, 21, 55, or 65). In some cases, server SV10 and/or the age verification module may be implemented to apply a fixed minimum age (e.g., 18, 21, or 65), such that the minimum age may be implied by request RQ20 rather than specified. Alternatively, request RQ20 may be implemented to specify an index into a list of age groups.

In one example, server SV10 or the age verification module (e.g., VM20, VM30, VM50) produces response RS20 to include a binary value that indicates whether or not the cardholder meets the specified age criterion. In another example, server SV10 or the age verification module produces response RS20 to indicate the value of a probability that the cardholder meets the specified age criterion. Server SV10 or the age verification module may be configured to calculate such a probability value, for example, from a probability for each of one or more age groups that the cardholder is a member of the age group (e.g., as a sum of the probability, for each age group which meets the specified age criterion, that the cardholder is within the age group). In one such example, response RS20 indicates a 95% probability that the cardholder is older than 21. In another such example, response RS20 indicates a 100% probability that the cardholder is older than 18 and also a 97% probability that the cardholder is older than 21.

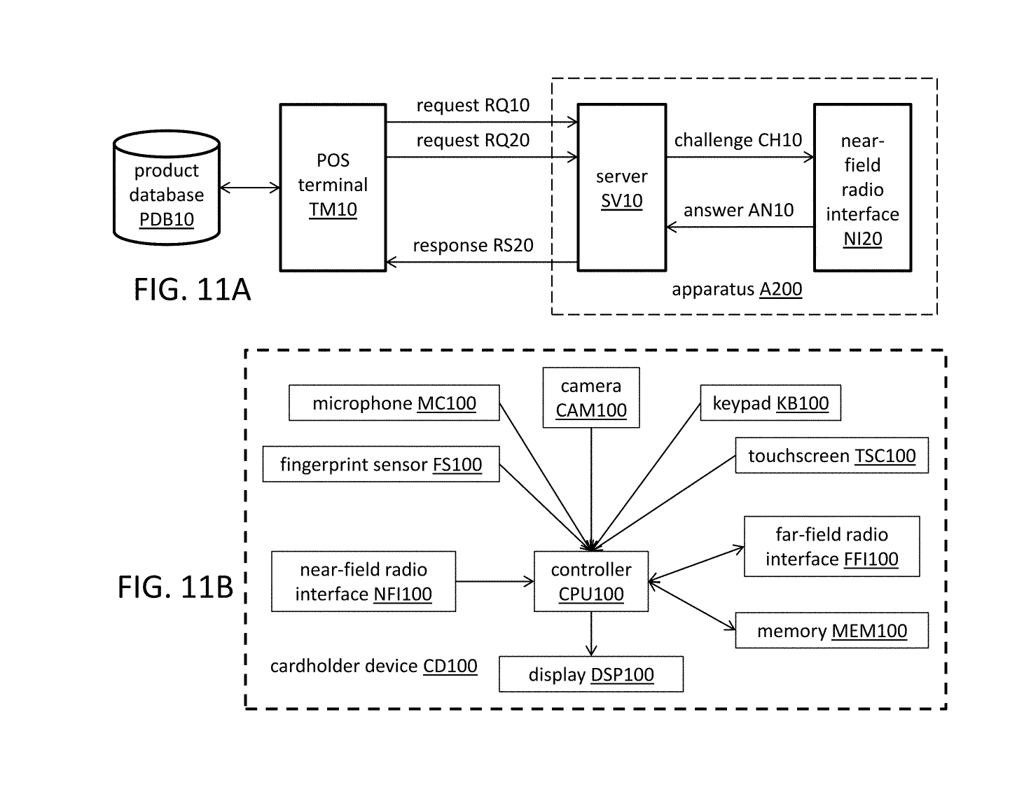

As noted above, the merchant device may be a POS device (e.g., a terminal, such as a register), such that apparatus A100 and the cardholder device may be present at the same physical location during the transaction. FIG. 11A shows a block diagram of a POS system that includes a POS terminal TM10 and an implementation A200 of apparatus A100. Apparatus A200 includes an implementation NI20 of network interface NI10 as a near-field radio interface configured to communicate contactlessly with the cardholder device (e.g., according to a near-field-communication (NFC) standard, such as ISO/IEC 18092, ECMA-340, and/or Bluetooth (e.g., Bluetooth Low Energy), and/or an RFID standard, such as ISO/IEC 14443 and/or ISO/IEC 18000-3). Apparatus A200 may be implemented, for example, as an NFC reader. Apparatus A200 may be connected to terminal TM10 via another interface (e.g., a serial interface, or another network interface). In the example of FIG. 11A, terminal TM10 communicates with product database PDB10 to receive information indicating that an item to be purchased is age restricted. Via interface NI20, a POS system as shown in FIG. 11A may be configured to support, for example, any one or more of the following contactless payment methods: MasterCard Contactless™, American Express ExpressPay™, Visa payWave™, Google Wallet™, CurrentC™, Android Pay™, and Apple Pay™.

In apparatus A200, server SV10 may be implemented as an instance of server SV20 or SV30 as described above that receives biometric information from the cardholder device via NFC interface NI20. Alternatively, apparatus A200 may be configured to exchange challenge CH10 and answer AN10 via NFC interface NI20 with an implementation CD20 or CD30 of a cardholder device as described herein that performs authentication and age verification.

In a further example, apparatus A200 is configured to exchange challenge CH10 and answer AN10 via NFC interface NI20 with an implementation CD50 of a cardholder device as described herein that performs authentication. In this case, server SV10 of apparatus A200 may be implemented as an instance of server SV50 as described herein in which age verification module VM50 is configured to produce an age verification result, based on stored age information, in response to receipt of an answer AN10 that indicates a successful authentication result.

FIG. 11B shows a block diagram of an implementation CD100 of cardholder device CD10 (e.g., of any of device CD20, CD30 and CD50). In order to provide payment information to a POS system, cardholder device CD100 may include one or more payment interfaces, such as a near-field radio interface NFI100 configured to communicate contactlessly with interface NI20 (e.g., according to an NFC standard, such as ISO/IEC 18092, ECMA-340, and/or Bluetooth, and/or an RFID standard, such as ISO/IEC 14443 and/or ISO/IEC 18000-3).

Device CD100 includes a display DSP100 configured to provide output to the user (e.g., a prompt to present biometric information in response to challenge CH10). Display DSP100 may also be implemented to display a QR code for presentation to the POS system as payment information. Device CD100 includes one or more input devices, such as touchscreen TSC100 and/or keypad KB100, that may be used for interacting with a payment app, authenticator AC20 or AC30, and/or module VM20 or VM30. Device CD100 may include a camera CAM100 that the user may use to take a photo (e.g., of the user's face) for use in authentication and/or age verification as described herein.

Device CD100 also includes at least one controller CPU100 (e.g., at least one microprocessor) configured to execute a payment app, authenticator AC20 or AC30, and/or module VM20 or VM30 and a memory MEM100 configured to store instructions and data associated with such execution. Device CD100 may also include a digital wallet app configured to execute on controller CPU100 and to provide payment information (e.g., a number of a payment card account linked to the digital wallet, or another label, such as a token associated with such an account). Such a digital wallet app may be configured to perform a card emulation operation (e.g., host card emulation or HCE). Memory MEM100 may also include secure storage (e.g., a secure element) to support such a digital wallet app. Device CD100 may include a fingerprint sensor FS100 and/or other user authentication device configured to provide authentication data to such a digital wallet app, and/or to provide biometric information to authenticator AC20 or AC30 and/or to age verification module VM20 or VM30 as described herein. In this example, device CD100 includes a microphone MC100 configured to provide biometric information to authenticator AC20 or AC30 and/or to age verification module VM20 or VM30.

Device CD100 may also include a far-field radio interface FFI100 configured to transmit and receive data relating to a payment transaction (e.g., data relating to authentication and/or age verification) via one or more data networks, such as one or more cellular data networks (e.g., 2G, 3G, 4G, LTE, etc.) and/or one or more local- and/or wide-area wireless data networks (e.g., Bluetooth, IEEE 802.11 or WiFi). Typical additional components of cardholder device CD100 that are not shown in FIG. 11B include a mobile operating system, such as a version of Android (Google), iOS (Apple Corp.), or Windows Phone (Microsoft), and hardware and software interfaces configured to allow controller CPU100 and the operating system to communicate with the various other components.

Upon successful completion of authentication and age verification as described herein, the underlying financial transaction (e.g., purchase of the items, including the age-restricted item(s), by the cardholder) may proceed. Such a transaction may be performed within a financial transaction card payment system, such as a credit card payment system using the MasterCard® interchange. The MasterCard® interchange is a proprietary communications standard promulgated by MasterCard International® Incorporated for the exchange of financial transaction data between financial institutions that are members of MasterCard International Incorporated®.

In a typical financial transaction card payment system, a financial institution called the “issuer” issues a financial transaction account, such as a credit card account, to a consumer (i.e., the cardholder), who uses the financial transaction account to tender payment for a purchase from a merchant. To accept payment with the financial transaction account, the merchant must normally establish an account with a financial institution that is part of the financial payment system. This financial institution is usually called the “merchant bank” or the “acquiring bank” or “acquirer bank.”

When the cardholder tenders payment for a purchase with a financial transaction account, and upon successful completion of authentication and age verification as described herein, the merchant requests authorization from the merchant bank for the amount of the purchase. Typically the request includes a token or other value that identifies the cardholder's account information (provided, for example, by a secure application executing on the cardholder device) and may also include a token or other value (possibly the same token or value) that confirms successful completion of the authentication. The merchant device may communicate electronically with the transaction processing computers of the merchant bank. Alternatively, a merchant bank may authorize a third party to perform transaction processing on its behalf. In this case, the merchant device may be configured to communicate with the third party. Such a third party is usually called a “merchant processor” or an “acquiring processor.”

Using the interchange, the computers of the merchant bank or the merchant processor will communicate with the computers of the issuer bank to determine whether the consumer's account is in good standing and whether the purchase is covered by the consumer's available credit line. Based on these determinations, the request for authorization will be declined or accepted. If the request is accepted, an authorization code is issued to the merchant.

An apparatus as disclosed herein (e.g., apparatus A100, A110, and/or A200) may be implemented in any combination of hardware with software, and/or with firmware, that is deemed suitable for the intended application. Unless indicated otherwise, any disclosure of an operation of an apparatus having a particular feature is also expressly intended to disclose a method having an analogous feature (and vice versa), and any disclosure of an operation of an apparatus according to a particular configuration is also expressly intended to disclose a method according to an analogous configuration (and vice versa). It is noted that the various methods disclosed herein (e.g., any among implementations of method M100, M200, M210, and/or M220) may be performed by one or more processors. The implementations of methods, schemes, and techniques disclosed herein (e.g., of method M100, M200, M210, and/or M220) may also be embodied, in one or more computer-readable storage media, as one or more sets of instructions readable and/or executable by one or more processors, such that the instructions cause one or more processors executing the instructions to perform the acts of such a method as disclosed herein. Such a storage medium may be a conventional read/write memory such as a magnetic disk, floppy disk, optical disc, compact-disc read-only-memory (CD-ROM), digital versatile disc (DVD), Blu-ray Disc™, magnetooptical storage, flash memory, random-access memory, transistor-based memory, magnetic tape, and/or any other non-transitory computer-readable memory device as is known in the art for storing and retrieving data. Significantly, such computer-readable storage media may be remotely located from such one or more processors and may be connected to such one or more processors via a network such as a local area network (LAN), a wide area network (WAN), or the Internet.

It is understood by those skilled in the art that instructions for such method embodiments may be stored on their respective computer-readable memory and executed by their respective processors. It is understood by those skilled in the art that other equivalent implementations can exist without departing from the spirit or claims of the invention.

The previous description of the embodiments is provided to enable any person skilled in the art to practice the disclosure. The various modifications to these embodiments will be readily apparent to those skilled in the art, and the generic principles defined herein may be applied to other embodiments without the use of inventive faculty. Thus, the present disclosure is not intended to be limited to the embodiments shown herein, but is to be accorded the widest scope consistent with the principles and novel features disclosed herein.

What is claimed is:

1. A method for age verification, said method comprising:
receiving, by a processor, a request by a merchant device to authenticate a cardholder and a request by the merchant device to verify an age of the cardholder;
in response to at least one among said requests, sending, by the processor and via a network interface, a challenge to a device of the cardholder;
receiving, by the processor and via the network interface, an answer by the device of the cardholder to the challenge; and
sending, by the processor, a response to said request to verify the age of the cardholder, wherein said response is based on the answer to the challenge,
wherein said answer to the challenge is based on biometric information of the cardholder.

2. The method of claim 1, wherein said answer to the challenge includes biometric information of the cardholder, and
wherein said method includes comparing the received biometric information of the cardholder to stored biometric information of the cardholder.

3. The method of claim 2, wherein said method includes estimating, based on said received biometric information, a current age of the cardholder.

4. The method of claim 2, wherein said method includes retrieving stored age information of the cardholder, and estimating a current age of the cardholder based on said stored age information.

5. The method of claim 1, wherein said answer to the challenge indicates a result of an authentication operation performed by the device of the cardholder and a result of an age verification operation performed by the device of the cardholder.

6. The method of claim 1, wherein said biometric information of the cardholder includes information from at least one among a fingerprint of the cardholder, a facial image of the cardholder, and a voice of the cardholder.

7. The method of claim 1, wherein said method comprises receiving said requests from the device of the cardholder.

8. An apparatus for age verification, said apparatus comprising:
a network interface; and
a server configured:
to receive a request by a merchant device to authenticate a cardholder and a request by the merchant device to verify an age of the cardholder;
to send, via the network interface and in response to at least one among said requests, a challenge to a device of the cardholder;
to receive, via the network interface, an answer by the device of the cardholder to the challenge; and
to send a response to said request to verify the age of the cardholder, wherein said response is based on the answer to the challenge,
wherein said answer to the challenge is based on biometric information of the cardholder.

9. The apparatus of claim 8, wherein said answer to the challenge includes biometric information of the cardholder, and
wherein said server is configured to compare the received biometric information of the cardholder to stored biometric information of the cardholder.

10. The apparatus of claim 9, wherein said server is configured to estimate, based on said received biometric information, a current age of the cardholder.

11. The apparatus of claim 9, wherein said apparatus includes a database configured to store age information of the cardholder, and
wherein said server is configured to estimate a current age of the cardholder based on said stored age information.

12. The apparatus of claim 8, wherein said answer to the challenge indicates a result of an authentication operation performed by the device of the cardholder and a result of an age verification operation performed by the device of the cardholder.

13. The apparatus of claim 8, wherein said biometric information of the cardholder includes information from at least one among a fingerprint of the cardholder, a facial image of the cardholder, and a voice of the cardholder.

14. The apparatus of claim 8, wherein said server is arranged to receive said requests, via the network interface, from the device of the cardholder.

15. A non-transitory computer-readable medium encoded with data and instructions for age verification, when executed by at least one processor the instructions causing the at least one processor to:
receive a request by a merchant device to authenticate a cardholder and a request by the merchant device to verify an age of the cardholder;
in response to at least one among said requests, send, via a network interface, a challenge to a device of the cardholder;
receive, via the network interface, an answer by the device of the cardholder to the challenge; and
send a response to said request to verify the age of the cardholder, wherein said response is based on the answer to the challenge,
wherein said answer to the challenge is based on biometric information of the cardholder.

16. The medium of claim 15, wherein said answer to the challenge includes biometric information of the cardholder, and
wherein said instructions include instructions which when executed by the at least one processor cause the at least one processor to compare the received biometric information of the cardholder to stored biometric information of the cardholder.

17. The medium of claim 16, wherein said instructions include instructions which when executed by the at least one processor cause the at least one processor to estimate, based on said received biometric information, a current age of the cardholder.

18. The medium of claim 16, wherein said instructions include instructions which when executed by the at least one processor cause the at least one processor to retrieve stored age information of the cardholder and estimate a current age of the cardholder based on said stored age information.

19. The medium of claim 15, wherein said answer to the challenge indicates a result of an authentication operation performed by the device of the cardholder and a result of an age verification operation performed by the device of the cardholder.

20. The medium of claim 15, wherein said biometric information of the cardholder includes information from at least one among a fingerprint of the cardholder, a facial image of the cardholder, and a voice of the cardholder.
